(19) United States
(12) Patent Application Publication
(10) Pub. No.: US 2026/0163214 A1
(43) Pub. Date: Jun. 11, 2026

(54) ENERGY SUPPLY DEVICE COMPRISING AT LEAST ONE CURRENT-DISCONNECTING ELEMENT

(71) Applicant: Hilti Aktiengesellschaft, Schaan (LI)

(72) Inventors: Robert STANGER, Kaufbeuren (DE); Klaus HAUSER, Schwabmünchen (DE); Andreas GUGGEMOS, Bad Wörishofen (DE); Markus HARTMANN, Mauerstetten (DE)

(21) Appl. No.: 18/709,573

(22) PCT Filed: Nov. 11, 2022
(86) PCT No.: PCT/EP2022/081639

§ 371 Date: May 13, 2024

(30) Foreign Application Priority Data
Dec. 1, 2021 (EP) 21211575.2
Jan. 11, 2022 (EP) 22150887.2

(51) Int. Cl. H01M 50/583; H01M 50/247; H02J 7/60; H02J 7/62

(52) U.S. Cl. CPC H01M 50/583; H01M 50/247; H02J 7/62; H02J 7/663; H01M 2200/103

(57) ABSTRACT

An energy supply device, in particular for a power tool, wherein the energy supply device includes at least one current-disconnecting element having a rated current-carrying capacity I_N, the rated current-carrying capacity I_N of the at least one current-disconnecting element being greater than a value of the following expression: 1000·(DCR_I)\hat{d}−0.6, where DCR_I is the internal resistance of the energy supply device and is measured in accordance with standard IEC61960. A peak current-carrying capacity I_P of the at least one current-disconnecting element for a loading duration of at least 100 milliseconds can be greater than 3000·(DCR_I)\hat{ }−0.6.

The present invention relates to an energy supply device, in particular for a power tool, wherein the energy supply device comprises at least one current-disconnecting element.

### BACKGROUND OF THE INVENTION

So-called cordless power tools, for example cordless screwdrivers, drills, saws, grinders or the like, may be connected to an energy supply device for power-supply purposes. The energy supply device may comprise a multiplicity of energy storage cells, by means of which electrical energy can be received, stored and released again. If the energy storage device is connected to a power tool, the electrical energy stored in the energy storage cells can be fed to the consumers (e.g. a brushless electric motor) of the power tool. For charging purposes, i.e. for loading the energy storage cells with electrical energy, the rechargeable battery is connected to a charging device, such as a charger, so that electrical energy can reach the energy storage cells.

### SUMMARY OF THE INVENTION

Modern energy supply devices are able to deliver high constant currents. As a result of a conservative design of protection devices, however, it may happen that in particular very powerful energy supply devices cannot optimally deliver their power to the apparatus which they are intended to supply with electrical energy. Consequently, situa-tions may arise in which the electrical potential of an energy supply device cannot be optimally utilized since the transfer of the corresponding powers or electric currents is restricted by the protection devices in the energy supply device.

By way of example, US 2012 0293 096 A1 discloses a power tool with a battery pack that can be connected to the power tool. DE 10 2013 214 726 A1 describes an arrangement for electrical safeguarding vis-à-vis a potential short circuit or an overload in a DC power supply network with a system-dictated variable internal source resistance.

It is an object of the present invention to overcome the deficiencies and disad-vantages of the prior art and to provide an energy supply device which has an improved high-current capacity, without in so doing giving rise to safety risks for the energy supply device, the connection partner, here a power tool, or the user of the system comprising energy supply device and power tool.

The invention provides an energy supply device, in particular for a power tool, wherein the energy supply device comprises at least one current-disconnecting element having a rated current-carrying capacity I_N, the rated current-carrying capacity I_N of the at least one current-disconnecting element being greater than or equal to a value of the following expression: 1000. (DCR_I)\hat{ }−0.6, where DCR_I is the internal resistance of the energy supply device and is measured in accordance with standard IEC61960. The rated current-carrying capacity I_N of the at least one current-disconnecting element thus satisfies the relation

$$I\_N > 1000 \cdot ( DCR\_I ) \hat{} - 0.6 or I\_N > 1000 \cdot {( DCR\_I )}^{- 0.6} .$$

Preferably, the rated current-carrying capacity I_N of the at least one current-disconnecting element is greater than a thousand times the expression: (DCR_I)\hat{ }−0.6. The internal resistance of the energy supply device measured in accordance with standard IEC61960 is preferably a DC resistance. It is preferred in the context of the invention for the rated current-carrying capacity I_N of the current-disconnecting element to be specified in the unit amperes (A), and likewise the peak current-carrying capacity I_P. The internal resistance DCR_I of the energy supply device is preferably specified in the unit milliohms (mohms), in which case the above formula expression can be calculated using the numerical value of the internal resistance DCR_I which results when the unit milliohms (mohms) is used, and the numerical value of the rated current-carrying capacity I_N of the current-disconnecting element which results when the unit becomes amperes (A).

The energy supply device comprising the at least one current-disconnecting element is configured particularly well for being used in energy supply devices which can deliver constant currents in a range of 50 amperes (A), preferably more than 70 A, and most preferably more than 100 A. Such energy supply devices can supply primarily powerful power tools with electrical energy. Advantageously, the invention can be used to provide an energy supply device capable of handling high currents, i.e. an energy supply device which, due to its protection function, is capable of handling and withstanding such high constant currents well without thermal overloads or other impairments occurring. The energy supply device is preferably an energy supply device which is configured to output particularly high currents, in particular constant currents of more than 50 amperes, preferably more than 70 amperes, and most preferably more than 100 amperes.

The inventors have recognized that the high-current capacity of the energy supply device can be significantly improved by the invention. In the context of the invention, it is preferred to choose the current-disconnecting elements of the energy supply device depending on the internal resistance of the energy supply device. In the context of the invention, it is preferred in particular to define the dimensioning and/or design of the energy supply device depending on the internal resistance of the energy supply device. It is thereby possible to provide particularly tailor-made protection solutions for the energy supply device which advantageously allow an optimum power from the energy supply device to be made usable for the power tool. In particular, the invention enables surprisingly high peak powers to be withdrawn from the energy supply device without the at least one current-disconnecting element preventing a current flow from the energy supply device in the direction of the power tool.

It is preferred in the context of the invention for the internal resistance DCR_I of the energy supply device to be measured once during the development of the energy supply device and then to be stored in the energy supply device, for example perma-nently in a storage device. This advantageously makes it possible to ensure that the essential measurement conditions resulting from standard IEC61960, such as “measurement at room temperature” and/or “compliance with a rest time of 1 to 4 hours before the measurement”, are complied with. Further essential measurement conditions may result from generally recognized industry standards, such as, for example, the measurement being carried out with the energy supply device having a state of charge of 50%. In particular, continuous monitoring of the internal resistance DCR_I of the energy supply device is not implemented in the context of the present invention. Furthermore, the internal resistance DCR_I of the energy supply device is preferably not measured in real time, but rather—as explained above—once in the course of the development process of the energy supply device. By virtue of this preferably one-off measurement of the internal resistance DCR_I, the energy supply device can be designed optimally.

It is preferred in the context of the invention for the formulation “internal resistance DCR_I of the energy supply device” to denote the internal resistance of the entire energy supply device that is measured in accordance with standard IEC61960 and generally recognized industry standards, i.e. in particular the internal resistance ascertained in this way for all the energy storage cells of the energy supply device, and the electronics of the energy supply device. In other words, the formulation “internal resistance DCR_I of the energy supply device” denotes the sum of the internal resistances of the components of the energy supply device of the power tool, such as energy storage cells and electronics, said internal resistances being measured in accordance with standard IEC61960 and in accordance with generally recognized industry standards

The at least one current-disconnecting element can be in particular a fuse or a fuse device. Such fuses or fuse devices are preferably configured to interrupt an electrical circuit if the electric current exceeds a defined current intensity for longer than a pre-defined time. In the context of the present invention, the at least one current-disconnecting element is part of the energy supply device, wherein the energy supply device can be connected to a power tool in order to supply the power tool with electrical energy. By way of example, the at least one current-disconnecting element of the present energy supply device can be embodied as an activatable current-disconnecting element.

It is preferred in the context of the invention for the rated current-carrying capacity to correspond to that current (preferably without temporal limitation) which the component still just withstands without breaking down or being activated, that is to say that said current can theoretically flow for an infinite time without damage to the component occurring. If the rated current-carrying capacity is exceeded—for example owing to the fact that a current flows which is greater than the rated current-carrying capacity—the component may incur damage. Preferably, the rated current-carrying capacity (in amperes) corresponds preferably to that current for which the at least one current-disconnecting component is activated or triggered. In one exemplary embodiment of the invention, for example, a current-disconnecting component having a rated current-carrying capacity of 60 A can be installed in an energy supply device. In this exemplary embodiment, it is then preferred for the current-disconnecting component to trigger at currents which are greater than 60 A. It is preferred in the context of the invention for the current-disconnecting component to trigger and bring about disconnection of the current path more rapidly, the greater the extent to which the rated current-carrying capacity is exceeded. In this exemplary embodiment, it is preferred, for example, for the current-disconnecting component not to trigger or be activated at currents of less than 60 A, to trigger at currents starting from 70 A after a waiting time of 3 seconds, for example, and to trigger or be activated at currents which are greater than 200 A, for example, after a waiting time of less than 1 second, preferably less than 0.1 second. In other words, the speed at which the current-disconnecting component is activated may depend on the extent to which the rated current-carrying capacity is exceeded, i.e. the magnitude of a difference and/or delta between the rated current-carrying capacity and the current ac-tually measured.

In the context of the invention, that preferably means that the current-disconnecting element can be activated by a signal of a microcontroller of the energy supply device and/or of the power tool, with which the energy supply device can be present in a connected fashion. In this configuration of the invention, the microcontroller of the energy supply device and/or the power tool can establish that an excessively high electric current flows for an excessively long time, whereupon the microcontroller is able to activate the at least one current-disconnecting element of the energy supply device, such that a current flow can be interrupted. In order to ascertain that an excessively high electric current flows for an excessively long time, the energy supply device can have a suitable sensor system and evaluation means. Furthermore, in this configuration of the invention, the energy supply device comprises corresponding communication means in order to transmit an activation signal from the microcontroller to the at least one current-disconnecting element of the energy supply device. Said communication means can be embodied in wireless or wired form. The use of an activatable current-disconnecting element has proved to be particularly advantageous because in this configuration of the invention the current-disconnecting element can be deactivated as soon as the activation reasons no longer apply. In other words, if the microcontroller ascertains that an excessively high current is no longer flowing or has no longer flowed for a relatively long period of time, then the current-disconnecting element can be deactivated and current conduction can be re-established. Consequently, in this configuration of the invention, current disconnection is embodied in reversible fashion by virtue of its being effected by electronic means.

In another exemplary embodiment of the invention, the at least one current-disconnecting element can be embodied as a fusible link. In the context of the invention, the response of a fusible link is referred to as “passive triggering” of the current-disconnecting element since it is not externally controllable. In yet another configuration of the invention, the at least one current-disconnecting element can be embodied as a MOSFET or comprise a MOSFET. Such metal oxide semiconductor field effect transis-tors (“MOSFETs”) have proved to be particularly effective fuses in an energy supply device for a power tool.

Besides the capability of conducting high currents, tests have shown that, by means of the invention, the energy supply device can also be protected particularly effectively against an excessively high current load, for example as a result of an external short circuit. In other words, not only does the invention improve the current-carrying capacity of the energy supply device but the invention also provides an effective protection solution for an energy supply device, the energy supply device being suitable in particular for being used in conjunction with a power tool.

It is preferred in the context of the invention for the rated current-carrying capacity I_N of the at least one current-disconnecting element to be greater than a value of the following expression: 1750·(DCR_I)\hat{ }−0.6, preferably greater than a value of the expression: 2500·(DCR_I)\hat{ }−0.6, where DCR_I is the internal resistance of the energy supply device and is measured in accordance with standard IEC61960. Preferably, the rated current-carrying capacity I_N of the at least one current-disconnecting element is greater than 1750 times the expression: (DCR_I)\hat{ }−0.6 or greater than 2500 times the expression: (DCR_I)\hat{ }−0.6. If the energy supply device has a rated current-carrying capacity I_N in the ranges mentioned, firstly the energy supply device stands out from the prior art; secondly the high-current-carrying capacity of the energy supply device can be improved further. In accordance with these exemplary embodiments of the invention, the rated current-carrying capacity I_N of the at least one current-disconnecting element satisfies the relations

$$I\_N > 1750 \cdot ( DCR\_I ) \hat{} - 0.6 or I\_N > 1750 \cdot {( DCR\_I )}^{- 0.6} or$$

$$I\_N > 2500 \cdot ( DCR\_I ) \hat{} - 0.6 or I\_N > 2500 \cdot {( DCR\_I )}^{- 0.6} .$$

It is preferred in the context of the invention for the at least one current-disconnecting element to have a peak current-carrying capacity I_P, the peak current-carrying capacity I_P for a loading duration of at least 100 milliseconds being greater than a value of the following expression: 3000·(DCR_I)\hat{ }−0.6, where DCR_I is the internal resistance of the energy supply device and is measured in accordance with standard IEC61960. In the context of the invention, a peak constitutes a local maximum of the current-carrying capacity, such a peak having a duration of preferably at least 100 milliseconds (ms) in the context of the present invention. Advantageously, the at least one current-disconnecting element of the energy supply device is configured to allow through or to withstand a peak current of 3000·(DCR_I)\hat{ }−0.6. Consequently, in this configuration of the invention the at least one current-disconnecting element satisfies the relation

$$I\_P > 3000 \cdot ( DCR\_I ) \hat{} - 0.6 or I\_P > 3000 \cdot {( DCR\_I )}^{- 0.6} .$$

Preferably, the current-disconnecting element has the peak current-carrying capacity I_P in the ranges mentioned. It is preferred in the context of the invention for the peak current-carrying capacity I_P of the at least one current-disconnecting element to be greater than a value of the following expression: 5250·(DCR_I)\hat{ }−0.6, preferably greater than a value of the expression: 7500·(DCR_I)\hat{ }−0.6, where DCR_I is the internal resistance of the energy supply device and is measured in accordance with standard IEC61960. In accordance with these exemplary embodiments of the invention, the peak current-carrying capacity I_P of the at least one current-disconnecting element satisfies the relations

$$I\_P > 5250 \cdot ( DCR\_I ) \hat{} - 0.6 or I\_P > 5250 \cdot {( DCR\_I )}^{- 0.6} or$$

$$I\_P > 7500 \cdot ( DCR\_I ) \hat{} - 0.6 or I\_P > 7500 \cdot {( DCR\_I )}^{- 0.6} .$$

Preferably, the peak current-carrying capacity I_P of the at least one current-disconnecting element is greater than 5250 times the expression: (DCR_I)\hat{ }−0.6 or greater than 7500 times the expression: (DCR_I)\hat{ }−0.6.

It is preferred in the context of the invention for a current load in the energy supply device to be distributable substantially uniformly among the current-disconnecting elements if the energy supply device comprises more than one current-disconnecting element In the context of the invention, that preferably means that the current loads carried by the individual current-disconnecting elements differ from one another by less than 5%. In other words, the current loads of the individual current-disconnecting elements fluctuate by not more than 5% or they lie in a corridor of +/−5%. The substantially uniform distribution of the current load among a plurality of current-disconnecting elements can be achieved for example by the current-disconnecting elements being connected in par-allel within the energy supply device. The energy supply device comprises a positive pole and a negative pole, wherein the current-disconnecting element can be present in a manner connected to the positive pole or the negative pole if the energy supply device comprises exactly one current-disconnecting element. If the energy supply device comprises more than one current-disconnecting element, these current-disconnecting elements are preferably present in a manner connected in parallel, wherein the units comprising par-allel-connected current-disconnecting elements can be present in each case in a manner connected to the positive pole or to the negative pole of the energy supply device (cf.

### FIGURES

It is preferred in the context of the invention for a total internal resistance DCR_ges of the energy supply device to be greater than 20 milliohms (mohms).

It is preferred in the context of the invention for the energy supply device to comprise at least one energy storage cell (“cell”), wherein the at least one cell has an internal resistance DCR_I of less than 10 milliohms (mohm). In preferred configurations of the invention, the internal resistance DCR_I of the at least one cell can be less than 8 milliohms and preferably less than 6 milliohms. Here, the internal resistance DCR_I is preferably measured in accordance with standard IEC61960. A low internal resistance DCR_I is advantageous, as this means that unwanted heat that needs to be dissipated does not arise at all. The internal resistance DCR_I is, in particular, a DC resistance which can be measured in the interior of a cell of the energy supply device. The internal resistance DCR_I can of course also assume intermediate values such as 6.02 milliohms; 7.49 milliohms; 8.33 milliohms; 8.65 milliohms or 9.5 milliohms.

It has been found that, with the internal resistance DCR_I of the at least one cell of less than 10 milliohms, it is possible to provide an energy supply device which has particularly good thermal properties in the sense that it can be operated particularly well at low temperatures, wherein the cooling expenditure can be kept surprisingly low. In particular, an energy supply device with a cell internal resistance DCR_I of less than 10 milliohms is particularly well suited to supplying electrical energy to particularly powerful power tools. Such energy supply devices can therefore make a valuable contribution to allowing storage-battery-operated power tools to be used even in areas of application that those skilled in the art previously assumed were not open to storage-battery-operated power tools.

Advantageously, such an energy supply device can be used to allow a battery-operated or storage-battery-operated power tool having an energy supply device according to the invention to be supplied with a high level of output power over a long period of time without damaging the surrounding plastics components or the cell chemistry within the cells of the energy supply device.

In the context of the invention, it is preferred that a ratio of a resistance of the at least one cell to a surface area A_Z of the at least one cell is less than 0.2 millionm/cm², preferably less than 0.1 millionm/cm² and most preferably less than 0.05 milliohm/cm². In the case of a cylindrical cell, the surface area of the cell may be formed for example by the outer surface of the cylinder as well as the top side and the bottom side of the cell. In the context of the invention, it can also be preferred that a ratio of a resistance of the at least one cell to a volume V_Z of the at least one cell is less than 0.4 milliohm/cm³, preferably less than 0.3 milliohm/cm³ and most preferably less than 0.2 milliohm/cm³. For conventional geometric shapes, such as cuboids, cubes, spheres or the like, a person skilled in the art knows the formulae for calculating the surface area or the volume of such a geometric body. In the context of the invention, the term “resistance” preferably denotes the internal resistance DCR_I which can preferably be measured in accordance with standard IEC61960. This is preferably a DC resistance.

It is preferred in the context of the invention for the at least one cell to have a heating coefficient of less than 1.0 W/(Ah·A), preferably less than 0.75 W/(Ah·A) and particularly preferably less than 0.5 W/(Ah·A). Furthermore, the at least one cell may be designed to output a current of greater than 1000 amperes/liter substantially constantly. The discharge current is indicated in relation to the volume V_Z of the at least one cell, wherein the cubic measure unit “liter” (I) is used as the unit for the volume. The cells according to the invention are therefore able to output a discharge current of substantially constantly greater than 1000 A per liter of cell volume. In other words, a cell with a volume of 1 liter is able to output a substantially constant discharge current of greater than 1000 A, wherein the at least one cell furthermore has a heating coefficient of less than 1.0 W/(Ah·A). In preferred configurations of the invention, the at least one cell of the energy supply device can have a heating coefficient of less than 0.75 W/(Ah·A), preferably less than 0.5 W/(Ah·A). The unit for the heating coefficient is watts/(ampere hours·amperes). The heating coefficient may of course also have intermediate values, such as 0.56 W/(Ah·A); 0.723 W/(Ah·A) or 0.925 W/(Ah·A).

The invention advantageously makes it possible to provide an energy supply device having at least one cell which exhibits reduced heating and therefore is particularly well suited to supplying power tools in which high powers and high currents, preferably constant currents, are desired for operation. In particular, the invention can be used to provide an energy supply device for a power tool in which the heat which is optionally created during operation of the power tool and when outputting electrical power to the power tool can be dissipated in a particularly simple and uncomplicated manner. Tests have shown that the invention can be used not just to more effectively dissipate existing heat. Rather, the invention prevents heat from being generated, or the quantity of heat generated during operation of the power tool can be considerably reduced using the invention. The invention can advantageously be used to provide an energy supply device which can supply electrical power in an optimum manner primarily also to power tools which have stringent requirements in respect of power and discharge current. In other words, the invention can provide an energy supply device for particularly powerful power tools with which heavy drilling or demolition work can be performed on construction sites for example.

In the context of the invention, the term “power tool” should be understood to mean a typical piece of equipment that can be used on a construction site, for example a building construction site and/or a civil engineering construction site. They may be hammer drills, chisels, core drills, angle grinders or cut-off grinders, cutting devices or the like, without being restricted thereto. In addition, auxiliary devices such as those oc-casionally used on construction sites, such as lamps, radios, vacuum cleaners, measur-ing devices, construction robots, wheelbarrows, transport devices, feed devices or other auxiliary devices, can be “power tools” in the context of the invention. The power tool may in particular be a mobile power tool, wherein the energy supply device may be used in particular also in stationary power tools, such as frame-mounted drills or circular saws. However, preference is given to hand-held power tools that are, in particular, operated using a storage battery or battery.

It is preferred in the context of the invention for the at least one cell to have a temperature cooling half-life of less than 12 minutes, preferably less than 10 minutes, particularly preferably less than 8 minutes. In the context of the invention, this preferably means that, with free convection, a temperature of the at least one cell is halved in less than 12, 10 or 8 minutes. The temperature cooling half-life is preferably determined in an inoperative state of the energy supply device, that is to say when the energy supply device is not in operation, that is to say is not connected to a power tool. Energy supply devices with temperature cooling half-lives of less than 8 min have primarily been found to be particularly suitable for use in powerful power tools. The temperature cooling half-life can of course also have a value of 8.5 minutes, 9 minutes 20 seconds or of 11 minutes 47 seconds.

Owing to the surprisingly low temperature cooling half-life of the energy supply device, the heat generated during operation of the power tool or when it is charging re-mains within the at least one cell only for a short time. In this way, the cell can be re-charged particularly quickly and is rapidly available for re-use in the power tool. Moreo-ver, the thermal load on the components of the energy supply device or of the power tool having the energy supply device can be considerably reduced. As a result, the energy supply device can be preserved and its service life extended.

In the context of the invention, it is preferred for the at least one cell to be arranged in a battery pack of the energy supply device. A series of individual cells can preferably be combined in the battery pack and in this way inserted into the energy supply device in an optimum manner. For example, 5, 6 or 10 cells can form a battery pack, with integer multiples of these numbers also being possible. For example, the energy supply device may have individual cell strings, which may comprise, for example, 5, 6 or 10 cells. An energy supply device having, for example, three strings of five cells each can comprise, for example, 15 individual cells.

It is preferred in the context of the invention for the energy supply device to have a capacity of at least 2.2 Ah, preferably at least 2.5 Ah. Tests have shown that the capacity values mentioned are particularly well suited to the use of powerful power tools in the construction industry and meet the requirements there for the availability of electrical energy and the possible service life of the power tool particularly well.

The at least one cell of the energy supply device is preferably configured to output a discharge current of at least 20 A for at least 10 s. For example, a cell of the energy supply device can be designed to provide a discharge current of at least 20 A, in particular at least 25 A, for at least 10 s. In other words, the at least one cell of an energy supply device can be configured to provide a continuous current of at least 20 A, in particular at least 25 A.

It is likewise conceivable that peak currents, in particular short-term peak currents, may lead to intense heating of the energy supply device. Therefore, an energy supply device with powerful cooling, as can be achieved by the measures described here, is particularly advantageous. It is conceivable, for example, that the at least one cell of the energy supply device can provide at least 50 A for 1 second. In other words, in the context of the invention, it is preferred for the at least one cell of the energy supply device to be configured to provide a discharge current of at least 50 A for at least 1 s. Power tools can often require high powers for a short period of time. An energy supply device with cells able to output such a peak current and/or such a continuous current may therefore be particularly suitable for powerful power tools such as are used on construction sites.

It is preferred in the context of the invention for the at least one cell to comprise an electrolyte, wherein the electrolyte is preferably present in a liquid physical state at room temperature. The electrolyte can comprise lithium, sodium and/or magnesium, without being restricted thereto. In particular, the electrolyte may be lithium-based. Alter-natively or additionally, said electrolyte can also be sodium-based. It is also conceivable for the storage battery to be magnesium-based. The electrolyte-based energy supply device may have a rated voltage of at least 10 V, preferably at least 18 V, in particular of at least 28 V, for example 36 V. A rated voltage in a range of from 18 to 22 V, in particular in a range of from 21 to 22 V, is very particularly preferred. The at least one cell of the energy supply device can have, for example, a voltage of 3.6 V, without being restricted thereto.

It is preferred in the context of the invention that the energy supply device is charged, for example, at a charging rate of 1.5 C, preferably 2 C, and most preferably 3 C. A charging rate of xC can be understood as meaning the current intensity which is required to fully charge a discharged energy supply device in a fraction of an hour corresponding to the numerical value x of the charging rate x C. For example, a charging rate of 3 C allows the storage battery to be fully charged within 20 minutes.

It is preferred in the context of the invention that the at least one cell of the energy supply device has a surface area A_Z and a volume V_Z, wherein a ratio A_ZIV_Z of surface area to volume is greater than six times, preferably eight times, and particularly preferably ten times, the reciprocal of the cube root of the volume.

The expression that the surface area A_Z of the at least one cell is greater than, for example, eight times the cube root of the square of the volume V_Z can preferably also be expressed by the formula A_Z>8*(V_Z)\hat{ }(⅔). Written another way, this relationship can be described by the fact that the ratio (A_Z)/(V_Z) of surface area to volume is greater than eight times the reciprocal of the cube root of the volume.

In order to check whether the above relationship is satisfied, values in the same basic unit must always be used. For example, if a value for the surface area in m² is inserted into the above formula, a value in the unit m³ is preferably inserted for the volume. For example, if a value for the surface area in the unit cm² is inserted into the above formula, a value in the unit cm³ is preferably inserted for the volume. For example, if a value for the surface area in the unit mm² is inserted into the above formula, a value in the unit mm³ is preferably inserted for the volume.

Cell geometries which, for example, satisfy the relationship of A_Z>8*(V_Z)\hat{ }(⅔) advantageously have a particularly favorable ratio between the outer surface of the cell, which is decisive for the cooling effect, and the cell volume. The inventors have recognized that the ratio of surface area to volume of the at least one cell of the energy supply device has an important influence on the removal of heat from the energy supply device. The improved cooling capability of the energy supply device can advantageously be achieved by increasing the cell surface area given a constant volume and a low internal resistance of the at least one cell. In the context of the invention, it is preferred that a low cell temperature with a simultaneously high power output can preferably be made possible if the internal resistance of the cell is reduced. Reducing the internal resistance of the at least one cell can result in less heat being generated. In addition, a low cell temperature can by using cells in which the surface area A_Z of at least one cell within the energy supply device is greater than six times, preferably eight times, and particularly preferably ten times, the cube root of the square of the volume V_Z of the at least one cell. As a result, in particular the output of heat to the surrounding area can be improved.

It has been found that energy supply devices with cells which satisfy said relationship can be significantly better cooled than previously known energy supply devices with, for example, cylindrical cells. The above relationship can be satisfied, for example, by virtue of the fact that, although the cells of the energy supply device have a cylindrical basic shape, additional elements that increase the surface area are arranged on the surface thereof. Said elements can be, for example, fins, teeth or the like. Cells which do not have a cylindrical basic shape, but rather are shaped entirely differently, can also be used within the scope of the invention. For example, the cells of the energy supply device can have a substantially cuboidal or cubic basic shape. The term “substantially” is not unclear to a person skilled in the art here because a person skilled in the art knows that, for example, a cuboid with indentations or rounded corners and/or edges is also intended to come under the term “substantially cuboidal” in the context of the present invention.

It is preferred in the context of the invention for the at least one cell to have a cell core, wherein no point within the cell core is more than 5 mm away from a surface of the energy supply device. When the energy supply device is being discharged, for example when it has been connected to a power tool and work is being performed with the power tool, heat may be generated in the cell core. In this specific configuration of the invention, this heat can be transported on a comparatively short path as far as the surface of the cell of the energy supply device. The heat can be dissipated in an optimum manner from the surface. Therefore, such an energy supply device can exhibit good cooling, in particular comparatively good self-cooling. The time period until the limit temperature is reached can be extended and/or the situation of the limit temperature being reached can advantageously be entirely avoided. As a further advantage of the invention, a relatively homogeneous temperature distribution can be achieved within the cell core. This can result in uniform aging of the storage battery. This can in turn extend the service life of the energy supply device.

It is preferred in the context of the invention for the at least one cell to have a maximum constant current output of greater than 50 amperes, preferably greater than 70 amperes, most preferably greater than 100 amperes. The maximum constant current output is the quantity of current in a cell or an energy supply device that can be drawn without the cell or the energy supply device reaching an upper temperature limit. Possible upper temperature limits may lie in a region of 60° C. or 70° C., without being restricted thereto. The unit for the maximum constant current output is amperes.

In the case of all value ranges mentioned in the context of the present invention, it is always intended that all intermediate values are also considered to be disclosed. For example, values of between 50 and 70 A, that is to say 51, 62.3, 54, 65.55 or 57.06 amperes etc. for example, should also be considered to be disclosed in the case of the maximum constant current output. Furthermore, values of between 70 and 100 A, that is to say 72, 83.3, 96, 78.55, 87.25 or 98.07 amperes for example, should also be considered to be disclosed.

It is preferred in the context of the invention for the energy supply device to have a discharge C rate of greater than 80·t\hat{ }(−0.45), where the letter “t” stands for time in the unit seconds. The C rate advantageously allows quantification of the charging and discharge currents for energy supply devices, wherein the discharge C rate used here ren-ders possible, in particular, the quantification of the discharge currents of energy supply devices. For example, the maximum permissible charging and discharge currents can be indicated by the C rate. These charging and discharge currents preferably depend on the rated capacity of the energy supply device. The unusually high discharge C rate of 80·t\hat{ }(−0.45) advantageously means that the energy supply device can be used to achieve particularly high discharge currents which are required for operating powerful power tools in the construction industry. For example, the discharge currents can lie in a range of greater than 50 amperes, preferably greater than 70 amperes or even more preferably greater than 100 amperes.

In the context of the invention, it is preferred for the cell to have a cell temperature gradient of less than 10 kelvins. The cell temperature gradient is preferably a measure of temperature differences within the at least one cell of the energy supply device, wherein it is preferred in the context of the invention for the cell to have a temperature distribution that is as uniform as possible, that is to say for a temperature in an inner region of the cell to differ as little as possible from a temperature which is measured in the region of a lateral or outer surface of the cell.

### BRIEF DESCRIPTION OF THE DRAWINGS

Further advantages will become apparent from the following description of the figures. The figures, the description and the claims contain numerous features in combi-nation. A person skilled in the art will expediently also consider the features individually and combine them to form useful further combinations.

In the figures, identical components and components of identical type are desig-nated by the same reference signs.

In the figures:

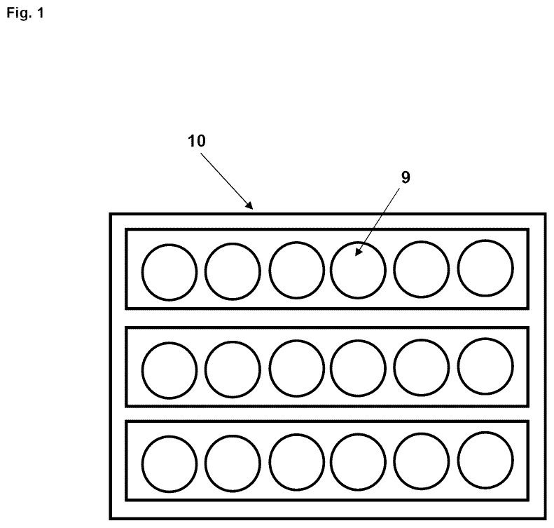

FIG. 1 shows a schematic sectional representation of a preferred configuration of the energy supply device

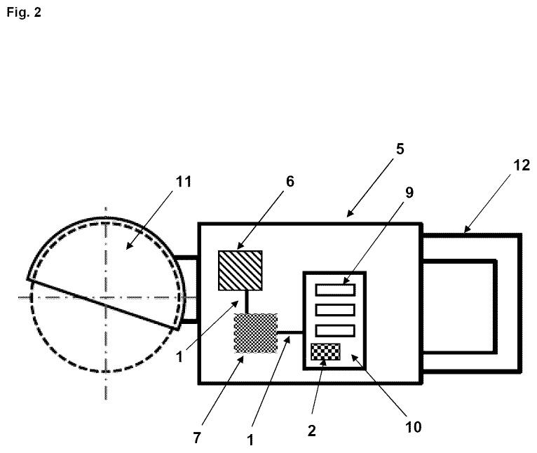

FIG. 2 shows a schematic sectional representation of a power tool with a preferred configuration of the energy supply device

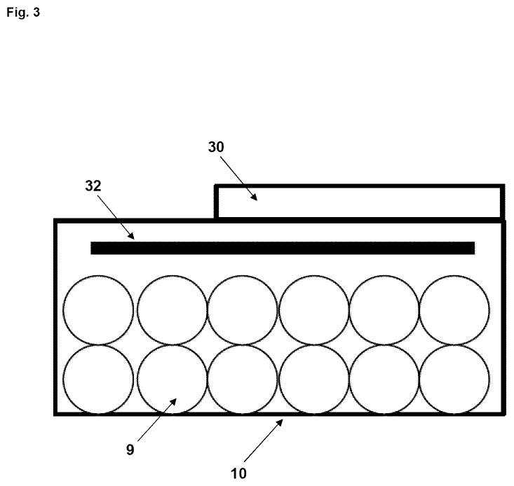

FIG. 3 shows a schematic sectional representation of a preferred configuration of the energy supply device

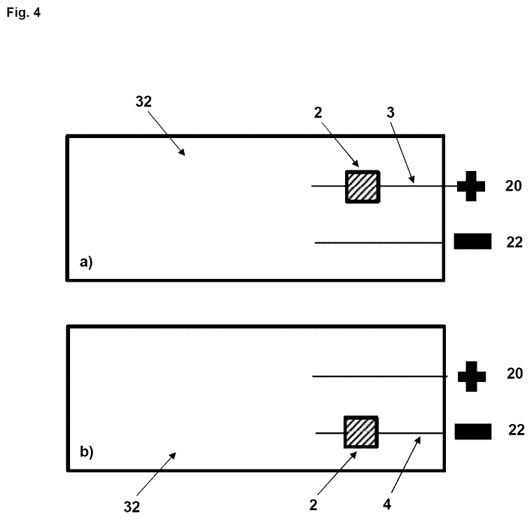

FIG. 4 shows a schematic representation of a preferred configuration of electronics of the energy supply device in the case of one current-disconnecting element

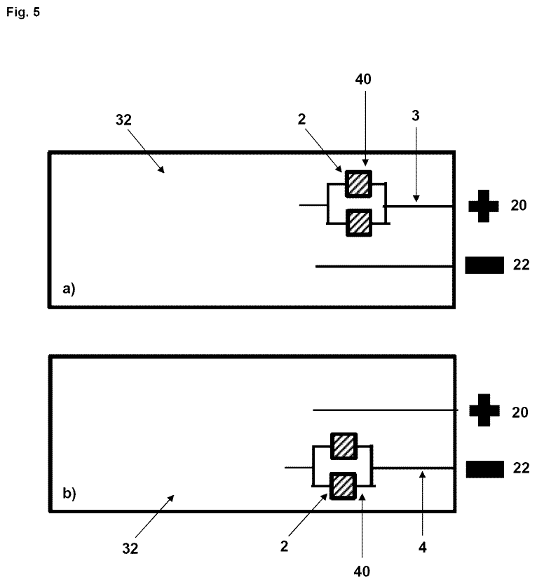

FIG. 5 shows a schematic representation of a preferred configuration of electronics of the energy supply device in the case of two current-disconnecting elements.

### DETAILED DESCRIPTION

FIG. 1 shows a schematic sectional representation of a preferred configuration of the energy supply device 10. The energy supply device 10 illustrated in FIG. 1 has eighteen energy storage cells 9, wherein the eighteen cells 9 are arranged in three strings within the energy supply device 10. In particular, the cells 9 are symbolized by the circles, while the strings are symbolized by the elongated rectangles surrounding the circles (“cells 9”).

FIG. 2 shows a schematic view of a power tool 5 with an energy supply device 10. The power tool 5 can be, for example, a cut-off grinder that has a cut-off wheel as the tool 11. The power tool 5 can have a handle 12 which is designed, for example, as a rear handle. In addition, the power tool 5 can have a motor 6, electronics 7 and/or an energy supply device 10, wherein the motor 6, the electronics 7 and/or the energy supply device 10 can be connected to one another via a current conductor 1. The energy supply device 10 comprises at least one current-disconnecting element 2, the energy supply device 10 illustrated in FIG. 2 comprising exactly one current-disconnecting element 2.

FIG. 3 shows a further schematic sectional representation of a preferred configuration of the energy supply device 10. Two strings of energy storage cells 9 are illustrated, each string comprising six energy storage cells 9. The energy supply device 10 illustrated in FIG. 3 comprises a total of twelve energy storage cells 9.

On its top side the energy supply device 10 comprises an interface 30 for connecting the energy supply device 10 to a power tool 5. By way of example, the energy supply device 10 can be inserted into a cavity of the power tool 5 or be secured to an exterior of the power tool 5. The energy supply device 10 preferably comprises electronics 32, which in the context of the invention may preferably also be referred to as “cell management system ZMS” or as “battery management system BMS”. The electronics 32 of the energy supply device 10 can comprise a microcontroller, which can be configured to activate a current-disconnecting element 2 of the energy supply device 10.

FIGS. 4a and 4b show possible exemplary embodiments of the electronics 32 of the energy supply device 10. In FIG. 4a 4a, the energy supply device 10 comprises exactly one current-disconnecting element 2, the one current-disconnecting element 2 being present in a manner arranged in the positive current path 3 of the electronics 32 of the energy supply device 10. The positive current path 3 is connected to the positive pole 20 of the energy supply device 10. In FIG. 4b, the energy supply device 10 like-wise comprises exactly one current-disconnecting element 2, the one current-disconnecting element 2 being present in a manner arranged in the negative current path 4 of the electronics 32 of the energy supply device 10. The negative current path 4 is connected to the negative pole 22 of the energy supply device 10. The electronics 32 of the energy supply device 10 are present in a manner arranged in the energy supply device 10.

FIGS. 5 and 5b show possible exemplary embodiments of the electronics 32 of the energy supply device 10 if the energy supply device 10 comprises more than one current-disconnecting element 2. In FIG. 5a, the energy supply device 10 comprises two current-disconnecting elements 2, for example, which together form a unit 40. In this unit 40, the current-disconnecting elements 2 are connected in parallel. In subfigure 5a, the unit 40 having the two current-disconnecting elements 2 is arranged in the positive current path 3 and connected to the positive pole 20 of the energy supply device 10. In FIG. 5b, the energy supply device 10 likewise comprises two current-disconnecting elements 2, which together form a unit 40. In this unit 40, too, the current-disconnecting elements 2 are connected in parallel. In FIG. 5b, the unit 40 having the two current-disconnecting elements 2 is arranged in the negative current path 4 and connected to the negative pole 20 of the energy supply device 10.

### LIST OF REFERENCE SIGNS

1 Current conductor
2 Current-disconnecting element
3 Positive current path
4 Negative current path
5 Power tool
6 Motor of the power tool
7 Electronics of the power tool
8 Interface of the power tool for receiving an energy supply device
9 Cell of an energy supply device, energy storage cell
10 Energy supply device
11 Tool of the power tool
12 Handle of the power tool
13 Operating element of the power tool, e.g. switch
20 Positive pole
22 Negative pole
30 Interface between power tool and energy supply device
32 Electronics of the energy supply device
40 Unit comprising preferably parallel-connected current-disconnecting elements

What is claimed is:

1-13. (canceled)

14. An energy supply device for a power tool, the energy supply device comprising:
at least one current-disconnector having a rated current-carrying capacity I_N, the rated current-carrying capacity I_N of the at least one current-disconnector being greater than a value of the following expression: 1000·(DCR_I)\hat{ }−0.6, where DCR_I is the internal resistance of the energy supply device and is measured in accordance with standard IEC61960.

15. The energy supply device as recited in claim 14 wherein the rated current-carrying capacity I_N of the at least one current-disconnector is greater than a value of the following expression: 1750·(DCR_I)\hat{ }−0.6.

16. The energy supply device as recited in claim 14 wherein the rated current-carrying capacity I_N of the at least one current-disconnector is greater than a value of the expression: 2500·(DCR_I)\hat{ }−0.6.

17. The energy supply device as recited in claim 14 wherein the at least one current-disconnector has a peak current-carrying capacity I_P, the peak current-carrying capacity I_P for a loading duration of at least 100 milliseconds being greater than a value of the following expression: 3000·(DCR_I)\hat{ }−0.6.

18. The energy supply device as recited in claim 17 wherein the peak current-carrying capacity I_P is greater than a value of the following expression: 5250·(DCR_I)\hat{ }−0.6.

19. The energy supply device as recited in claim 17 wherein the peak current-carrying capacity I_P is greater than a value of the following expression: 7500·(DCR_I)\hat{ }−0.6.

20. The energy supply device as recited in claim 14 wherein the at least one current-disconnector includes a plurality of current-disconnectors and a current load in the energy supply device is distributable uniformly among the current-disconnectors.

21. The energy supply device as recited in claim 14 wherein a total internal resistance DCR_ges of the energy supply device is greater than 20 milliohms.

22. The energy supply device as recited in claim 14 wherein the at least one current-disconnector is embodied as an activatable current-disconnecting element.

23. The energy supply device as recited in claim 14 wherein the at least one current-disconnector is embodied as a fusible link.

24. The energy supply device as recited in claim 14 wherein the at least one current-disconnector is embodied as a MOSFET or comprises a MOSFET.

25. The energy supply device as recited in claim 14 further comprising at least one energy storage cell, wherein the at least one energy storage cell has an internal resistance DCR_I of less than 10 milliohms.

26. The energy supply device as recited in claim 14 further comprising at least one energy storage cell having has a surface area A_Z and a volume V_Z, wherein a ratio (A_Z)/(V_Z) of surface area to volume is greater than six times a reciprocal of the cube root of the volume.

27. The energy supply device as recited in claim 14 further comprising at least one energy storage cell having has a surface area A_Z and a volume V_Z, wherein a ratio (A_Z)/(V_Z) of surface area to volume is greater than eight times a reciprocal of the cube root of the volume.

28. The energy supply device as recited in claim 14 further comprising at least one energy storage cell having has a surface area A_Z and a volume V_Z, wherein a ratio (A_Z)/(V_Z) of surface area to volume is greater than ten times a reciprocal of the cube root of the volume.

29. The energy supply device as recited in claim 14 further comprising at least one energy storage cell, wherein a ratio of a resistance of the at least one energy storage cell to a surface area A_Z of the at least one cell is less than 0.2 milliohm/cm².

30. The energy supply device as recited in claim 14 further comprising at least one energy storage cell, wherein a ratio of a resistance of the at least one energy storage cell to a surface area A_Z of the at least one cell is less than 0.1 milliohm/cm².

31. The energy supply device as recited in claim 14 further comprising at least one energy storage cell, wherein a ratio of a resistance of the at least one energy storage cell to a surface area A_Z of the at least one cell is less than 0.05 milliohm/cm².

32. The energy supply device as recited in claim 14 wherein the energy supply device has a capacity of at least 2.2 Ah,

33. The energy supply device as recited in claim 14 wherein the energy supply device has a capacity of at least 2.5 Ah,
